(19) United States
(12) Patent Application Publication
(10) Pub. No.: US 2013/0163796 A1
(43) Pub. Date: Jun. 27, 2013

(54) VERSATILE PORTABLE LAPTOP VIDEO MONITOR WITH KEYBOARD

(71) Applicant: Norman Li, Chicago, IL (US)

(72) Inventor: Norman Li, Chicago, IL (US)

(21) Appl. No.: 13/335,009

(22) Filed: Dec. 22, 2011

(51) Int. Cl. H04R 5/02

(52) U.S. Cl. 381/306

(57) ABSTRACT

In a versatile video and audio monitor, a portable laptop chassis is provided with a flat panel video display in a lid connected by a foldable hinge. No computer is provided in the chassis. The chassis has a keyboard, touchpad, rear panel, left side panel, right side panel, and front panel. At least one of the panels has an HDMI video input port with digital audio, a VGA video input port, a host USB input port for connection to a PC or other host device, an audio input port, at least one USB port for a peripheral device other than the host USB input port, a power connector, and left and right speakers. A power supply and charging circuit are also provided. The chassis further includes a powered USB hub connected to the USB ports, keyboard, and touchpad, and a display controller.

### BACKGROUND

For rack mounted computer servers, it has been known to provide what is known as a keyboard-video-mouse (KVM) which is a rack-mounted device having a monitor, a keyboard, and a pointing device (See U.S. Pat. No. 7,894,194). Such a device also known as a KVM module or switch may connect to computers also located within the rack such as by cables so that a human user can control and monitor the computer through a console 10 which is associated with the KVM module (See U.S. Pat. No. 7,894,194).

However, such KVM units are too large for use as a portable device and are not practical for freelance technical and consumer use. Furthermore, they do not have consumer-friendly features for connection to audio and video sources.

It has also been suggested to recycle a laptop for use as a portable/compact KVM console. However such a portable laptop has a computer internally thereof and is not possible to use with a variety of video output devices without major modifications.

### SUMMARY

It is an object to provide a portable monitor which is portable but also consumer-friendly from the standpoint of usage with a variety of audio and video sources.

In a versatile portable laptop video and audio monitor, a portable laptop chassis is provided with a flat panel video display in a lid connected by a foldable hinge to the chassis. No computer is provided in the chassis. The chassis has a keyboard and a touchpad. The chassis also has a rear panel, a left side panel, a right side panel, and front panel. At least one or more of the panels have mounted therein an HDMI video input port with digital audio, a VGA video input port, a host USB input port for connection to a PC or other host device, an audio input port, at least one USB port for a peripheral device other than the host USB input port, a power connector, and left and right stereo speakers. A power supply and charging circuit are also provided in the chassis. The chassis further includes a powered USB hub connected to the USB ports, keyboard, and touchpad, and a display controller with audio capability for the video display.

### BRIEF DESCRIPTION OF THE DRAWINGS

FIG. 1 is a perspective view of a versatile portable laptop video monitor with keyboard according to a preferred embodiment;

FIG. 2 is a perspective view of the monitor of FIG. 1 with the top lid in a closed position;

FIG. 3 is a rear view of the monitor of FIG. 2;

FIG. 4 is a left side view of the monitor of FIG. 2;

FIG. 5 is a right side view of the monitor of FIG. 2;

FIG. 6 is a bottom view of the monitor of FIG. 2; and

FIG. 7 is a circuit block diagram of the monitor of FIGS. 1 and 2.

### DESCRIPTION OF PREFERRED EXEMPLARY EMBODIMENTS

For the purposes of promoting an understanding of the principles of the invention, reference will now be made to preferred exemplary embodiments/best mode illustrated in the drawings and specific language will be used to describe the same. It will nevertheless be understood that no limitation of the scope of the invention is thereby intended, and such alterations and further modifications in the illustrated embodiments and such further applications of the principles of the invention as illustrated as would normally occur to one skilled in the art to which the invention relates are included.

A versatile portable laptop video monitor with keyboard according to one preferred exemplary embodiment is generally illustrated at 10 in FIG. 1. The monitor has no internal computer. The monitor has a flat panel video display 11 and a top lid 16. The flat panel display has a resolution of at least 720p, but resolution may be as high as 1080p depending on size.

The lid 16 with display 11 is connected by foldable hinges 15A, B to a laptop style chassis 14 for mobility.

To ensure a laptop style portability, the lid 16 has a maximum width of approximately 21 inches and a maximum height of approximately 15 inches. A maximum thickness is approximately ¼ inch. The flat panel video display 11 mounted in the lid 16 has a maximum width of approximately 20 inches and a maximum height of approximately 14 inches.

The chassis 14 has a maximum width of approximately 21 inches, a maximum depth of approximately 15 inches, and a maximum thickness of approximately 2 inches. Of course preferred embodiment dimensions may be considerably smaller than the above dimensions.

The chassis 14 has a keyboard 12 with an internal USB. A touchpad 13 as a mouse-like input device is located at a base of the keyboard 12 in the chassis 14. A trackpad 13 with associated left and right click input buttons 13A and 13B are provided for the touchpad 13.

The keyboard 12 is designed for touch-typing for long periods. The key caps may be metallic (aluminum caps for example) or high quality plastic. They are replaceable and back-lit for technicians who are hard on their equipment and sometimes work in dark areas. The backlight can be dimmed or turned off completely.

The touchpad 13 is multi-touch. Scrolling with two fingers is preferred. The buttons 13A, 13B are preferably physical push-down buttons and may be made of aluminum or high quality plastic, and extend to the edge of a palm rest. This makes it feel natural to click with the edge of one's thumb. The trackpad 13C and buttons 13A, 13B sit flush with each other to look and feel seamless.

The flat panel display 11 is mounted in the top lid 16 connected by the aforementioned foldable hinges 15A, B to the chassis 14.

The display 11 is of a sufficient size for readability but not too big to impede portability. Preferably it is of a 14 inch diagonal size. It should be big enough for desktop and gaming use, while portable enough for freelance tech or network administrative use. 1440×900 is a prefined resolution for this size (14-inch diagnol size desktop use). The display 11 should be LED-lit since such a panel is more durable and more energy efficient.

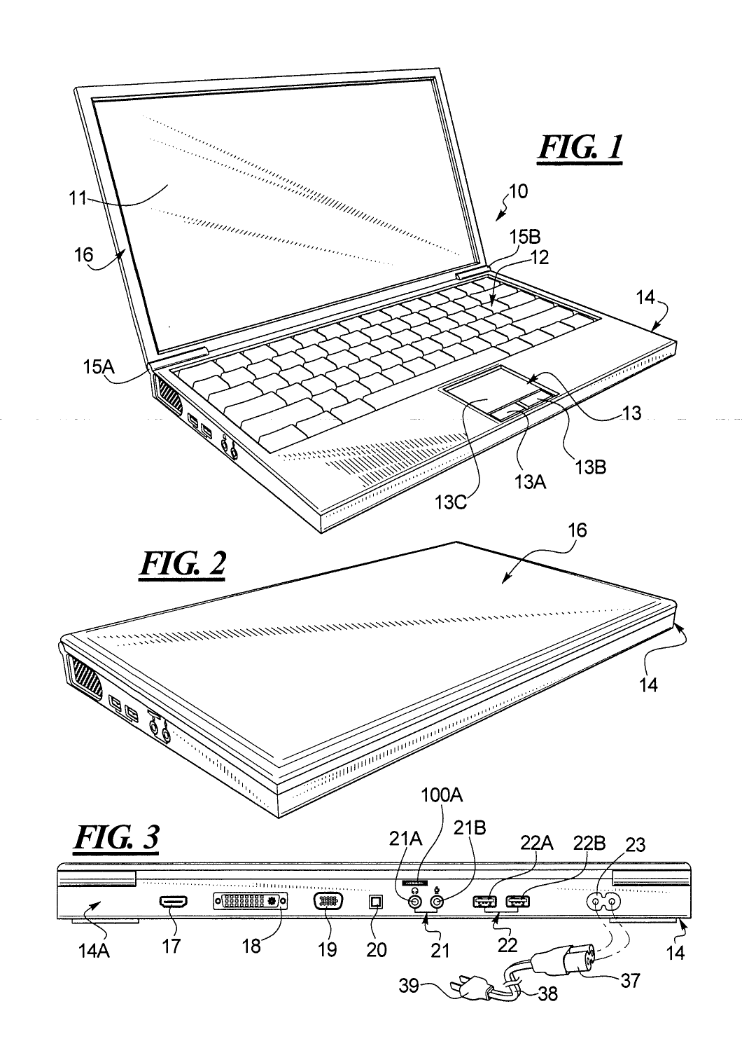

In FIG. 2 the top lid 16 has been closed down to rest on top of the chassis 14 to illustrate the compact size for mobility.

The chassis 14 may have an aluminum body and the top lid may also be aluminum or high quality plastic.

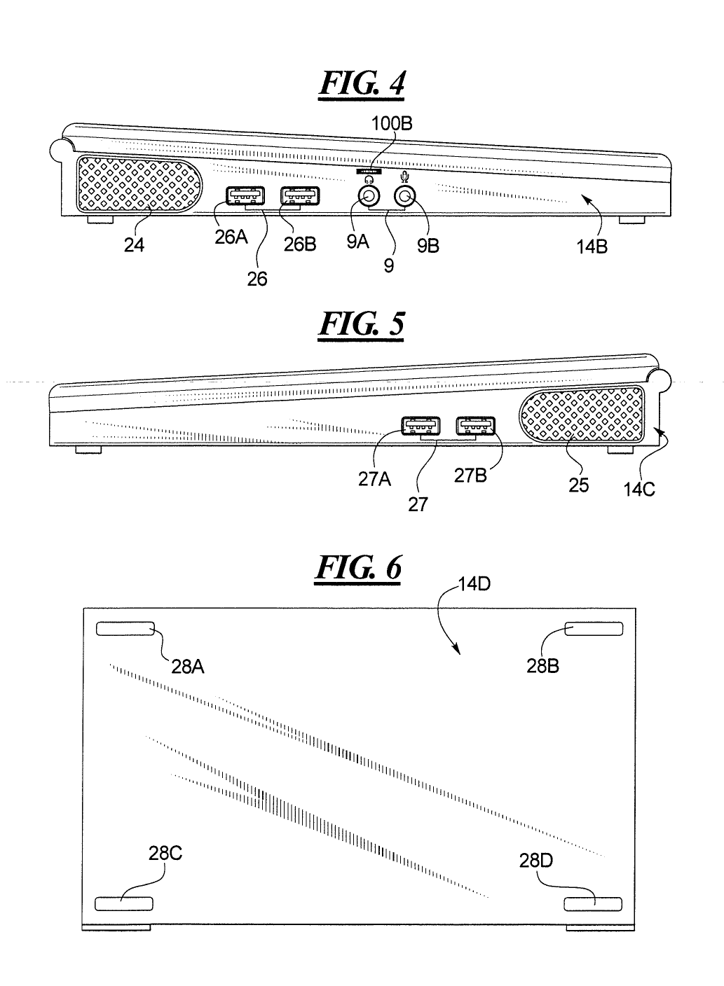

FIG. 3 shows a rear view of the monitor 10 as illustrated in FIG. 2 in which a rear panel 14A is shown. The rear panel 14A has a plurality of inputs and outputs described hereafter. From left to right as shown in FIG. 3 are the following: HDMI (High Definition Multimedia Interface) input port 17 with HDCP (High-Bandwidth Digital Content Protection) and digital audio; a DVI (Digital Video Interface) input port 18; a VGA (Video Graphics Array) (for example analog) input port 19; a host USB input port 20 for accepting a cable from a PC or other host device; an audio input/output port arrangement 21 (specifically a headphone output 21A and a microphone input 21 B); USB ports 22A, B for peripherals (USB flash drive, external USB mouse, etc.); and a male plug power connector 23 (to charge an internal battery and supply power to the monitor and the USB hub described hereafter).

The male plug 23 mounted on the rear panel 14A connects to a female power plug 37 connected to a 110 VAC power cord 38 connected to a power plug 39 to be received in a power outlet 40 as shown in FIG. 7 and discussed hereafter.

In the left side view of FIG. 4, a left side panel 14B is illustrated having the following components: a left stereo speaker 24; a USB port arrangement 26 having USB ports 26A and 26B which may be additional to the previously described USB ports 22A, 22B at the rear panel as illustrated in FIG. 3 or in lieu of those USB ports 22A, 22B of FIG. 3; and audio input/output port system 9 (for example analog) comprising ports 9A and 9B which may be additional to or in lieu of the analog audio input/output port system 21 shown on the rear panel in FIG. 3.

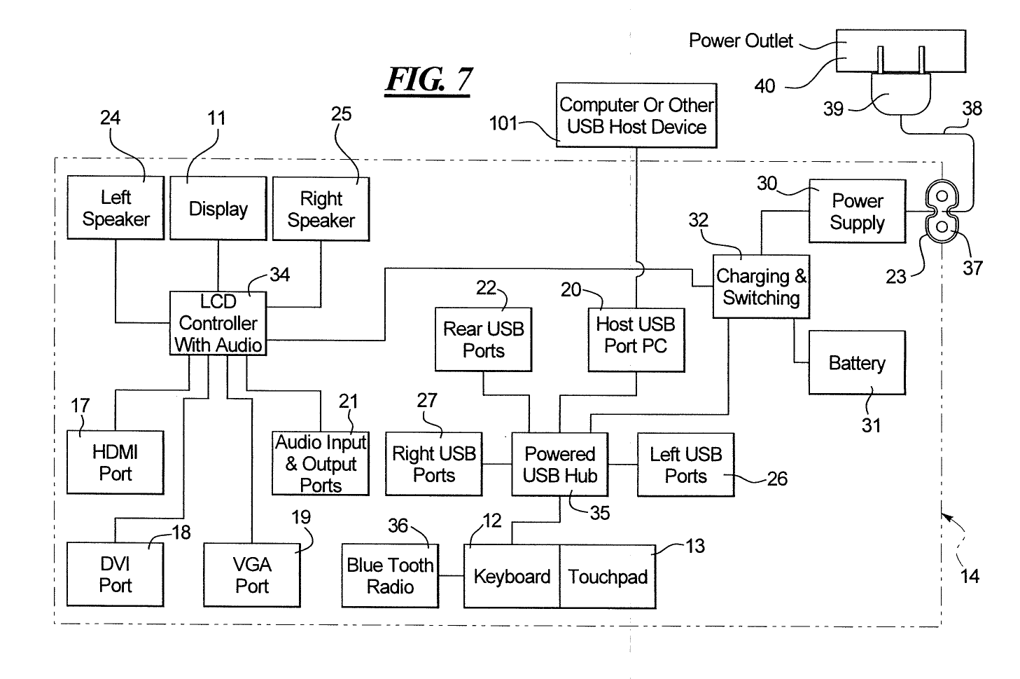

In the right side view of FIG. 5, the right side panel 14C may be observed having a USB port system 27 for peripherals comprising individual USB ports 27A, 27B which may be in addition to or in lieu of the USB ports 22A, B for peripherals on the rear panel as shown in FIG. 3 and/or in addition to the left side panel USB ports 26A, B shown in FIG. 4. Also a right stereo speaker 25 is provided. As shown in FIG. 6, on the bottom 14D of the chassis 14 rubber feet 28A-D are provided to assist in a non-slip placement of the monitor on a flat surface.

FIG. 7 illustrates a circuit block diagram for the monitor and power supplied to the monitor. A power supply 30 inside the chassis 14 is connected to a conventional 110 VAC power outlet 40 through male plug 23, female plug 37, power chord 38 and power plug 39 received in power outlet 40. The DC output from power supply 30 is fed to the circuitry located inside the chassis 14. More specifically, the DC power from power supply 30 is connected to a charging and switching block 32 inside the chassis 14 which also is connected to an optional battery 31 also located inside the chassis 14 for charging the battery 31 when it has a low charge. A first output from the charging and switching block 32 supplies power to a powered USB hub 35. Connected to the hub 35 are the rear USB ports 22, the host USB port 20 for connection to a PC or other USB host device 101, the left USB ports 26, the right USB ports 27, and the keyboard 12 with touchpad 13 each having internal USB.

Connected to keyboard 12 is a bluetooth radio 36. The use of a USB hub 35 provides universality if used for games, and thus a favorite gaming mouse may be utilized. It is convenient to plug the USB devices and not have to worry about reaching down to a tower, and it is also convenient for technicians to plug in flash drives and other devices without kneeling in an uncomfortable position. The monitor of this disclosure plugged into the computer or server's USB jack for keyboard/touchpad functionality also provides the user with more USB ports. They are spaced sufficiently apart to accommodate large USB devices without blocking the adjacent USB port. Two are provided on the right, two on the left, and two on the rear. This takes into account that one might not know which side will be physically blocked, and which will be free. This is particularly important consideration for technicians. It is also convenient for an engineer, since the keyboard and touchpad will be using the same USB hub to connect to the host (PC, Mac, or even game consoles—such as XBOX and PS3).

The same line-in and HDMI input powers the built-in speakers 24 and 25 by default. Only by plugging in a headphone in the jack will sound be output to pipe through the headphones, shutting off the built-in speakers. If one uses their own USB sound device, most likely the line-in jack would not be used. If, for some reason one has both connected, the PC only allows sound to go to one sound device in any event. Or one can also hit the mute key on the keyboard to mute the speakers.

Placement of speakers affects sound quality. The speakers are therefore angled internally to reflect the sound in a chamber before the sound actually comes out of the speaker grill. Speakers that are directed towards the ears sound sharp and painful and lack bass, while speakers directed elsewhere reflect the waves providing a more natural sound with the added benefit of perceived bass.

As shown in FIG. 7, the charging and switching block 32 also supplies power to an LCD controller 34 for the display 11 which is preferably an LCD panel. The LCD controller 34 includes audio capability and is connected to the left speaker 24 and to the right speaker 25. The controller 34 also connects to the HDMI port 17, the DVI port 18, the VGA port 19, and the audio input/output ports 21 (and also audio input/output ports 9 if provided on the chassis leftside panel.

The LCD controller 34 is able to allow HDMI (with HDCP), DVI, and VGA inputs. Since the controller accepts HDMI, it also has the ability to output audio. Thus a headphone jack for the user to plug in is provided. There is also a volume control which maybe for example, controlled through the keyboard or an external volume control 100A on back panel 14A as shown in FIG. 3 or 100B on left side panel 14B as shown in FIG. 4. This will also allow gamers to use their favorite headset/boom mic which sometimes have 2 mini jacks—one for mic, one for headphones.

The built-in power supply supplies power to all internal parts—USB hub, display, LCD controller, and of course, keyboard, backlight, and touchpad. An optional battery is provided for those who are road-warrior techs. One still needs cables for video and keyboard, but at least one does not need to hunt for a free power outlet, which sometimes does not exist. The battery may be provided as an option because a) it's an unnecessary expense for those who do not need it, b) those who won't need it will leave it plugged in, which will damage the battery over time, c) it is an unnecessary liability (see for example battery recalls), d) it's an unnecessary weight for those who don't want it. The power supply is built in so one does not have to carry a separate power supply.

USB hubs, flat panel LCD display 11, and LCD controller 34 with audio are all known prior art store-bought components well-known to those skilled in the art. The same is true of the charging and switching circuit 32 and power supply 30.

The versatile portable laptop video monitor with keyboard of the preferred exemplary embodiment thus provides a monitor with keyboard and touch-sensitive type input device like a mouse having audio speakers and a USB hub. Significantly the monitor does not have an internal computer but is connectable to a headless computer, to video game consoles, DVD players, Blu-ray players, and other video output devices. It has significant practicality for consumers and technicians since it has USB ports for peripherals (USB flash drive, USB headsets, USB memory card readers, external USB mouse, etc.) it will also work with video output from video devices that use HDMI, DVI and VGA ports. It is very useful for techs on-the-go, a network administrator who deals with head-less servers in a data center, LAN party goers (both PCs and consoles), and even everyday users.

The bluetooth radio 36 connects to the keyboard. The bluetooth radio is used for wireless audio, keyboard, and touchpad functions. The same functions are still available in wired forms (USB and audio cable). This will expand the use of the monitor to mobile devices such as iPhone, iPad, and Android phones and tablets with Bluetooth capabilities. Computers with Bluetooth will also be able to connect in wireless fashion to take advantage of these functions, but wired forms of connectivity for the same function are still available via USB and audio cables.

The monitor is useful for everyday users as a replacement for an unsightly separate monitor, keyboard, and mouse combo. Most desktops are already hidden because they are actually towers that sit on the floor, so all one would see is the integrated monitor, keyboard, and touchpad on the desktop, which looks like a laptop. But since it is small and closes up like a laptop, it also lends itself to be portable for other video-output devices such as DVD or Blu-ray players, smartphones with video-out capabilities such as iPhone and some Android phones, tablets, etc.

Audio is provided to the monitor by HDMI or analog mini jack. There is a mic mini jack pass-through for convenience. The built in speakers switch off automatically when headphones or headset is connected.

The portable monitor is like a laptop but has no internal computing power of its own and thus has no internal computer. It is a portable monitor with a keyboard and mouse type input using a touchpad.

A rechargeable battery pack is for convenient short-term use such as on-site client service and is optional.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

I claim as my invention:

1. A versatile portable laptop video and audio monitor, comprising:
a laptop chassis having a maximum width of 21 inches, a maximum depth of 15 inches, and a maximum thickness of 2 inches, a flat panel video display on a lid connected by a foldable hinge to the chassis such that the lid can be folded down on top of the chassis in compact fashion for portability, and no computer being provided in the chassis;
said chassis having a keyboard and a touchpad at a top surface thereof, said touchpad providing mouse-like input capability;
said chassis having a rear panel, a left side panel, a right side panel, and a front panel;
at least one or more of said panels having mounted therein an HDMI video input port with digital audio, a VGA video input port, a host USB input port for connection to a PC or other host device, an audio input port, at least one USB port for a peripheral device other than said host USB input port, a power connector, and left and right stereo speakers;
said chassis further including therein an internal AC to DC power supply connected to a power input port and an internal charging circuit; and
said chassis further including a powered USB hub connected to said USB ports, keyboard, and touchpad, and a display controller with audio capability for said video display.

2. The monitor of claim 1 wherein said video display has a resolution of at least 720p.

3. The monitor of claim 1 wherein said video display has a resolution of at least 1080p.

4. The monitor of claim 1 wherein said keyboard has an internal USB and said touchpad has an internal USB.

5. The monitor of claim 1 wherein at least two of said USB ports for peripherals are provided.

6. The monitor of claim 1 wherein in addition to said HDMI video input port and VGA video input port a DVI input port is provided.

7. The monitor of claim 1 wherein said HDMI input port is with HDCP.

8. The monitor of claim 1 wherein rubber feet are provided on a bottom panel of said chassis.

9. The monitor of claim 1 wherein an audio output is also provided for headphones and said audio input is for a microphone.

10. The monitor of claim 1 wherein a Bluetooth radio is provided.

11. The monitor of claim 1 wherein said flat panel video display has a maximum width of approximately 20 inches and a maximum height of approximately 14 inches.

12. The monitor of claim 1 wherein said lid has a maximum width of approximately 21 inches, a maximum height of approximately 15 inches, and a maximum thickness of approximately ¾ inch.

13. The monitor of claim 1 wherein key caps of said keyboard are metallic or high quality plastic.

14. The monitor of claim 1 wherein key caps of said keyboard are replaceable and back-lit.

15. The monitor of claim 1 wherein said touchpad has a trackpad and first and second function buttons.

16. The monitor of claim 1 when the chassis comprises a metallic or high quality plastic outer surface and the lid comprises a metallic or high quality plastic outer surface.

17. The monitor of claim 1 when the chassis rear panel has an HDMI port, a DVI port, VGA port, a host USB port for a PC, an audio output port and an audio input port, and a USB port; such chassis left side panel as a speaker, and a USB port; and said chassis right side panel has the speaker and a USB port.

18. The monitor of claim 17 wherein said left side panel has two of said USB ports and said right side panel has two of said USB ports.

19. The monitor of claim 18 wherein one of said chassis left and right side panels has an audio input and an audio output.

20. The monitor of claim 1 wherein said internal charging circuit is connected with an internal battery.

21. A versatile portable laptop video and audio monitor, comprising:
a laptop chassis having a maximum width of 21 inches, a maximum depth of 15 inches, and a maximum thickness of 2 inches, a flat panel video on a lid display connected by a foldable hinge to the chassis such that the lid can be folded down on top of the chassis in compact fashion for portability, and no computer being provided in the chassis;
said chassis having a keyboard and a touchpad at a top surface thereof, said touchpad providing mouse-like input capability;
said chassis having a rear panel, a left side panel, a right side panel, and a front panel;
at least one or more of said panels having mounted therein an HDMI video input port with digital audio, a VGA video input port; a host USB input port for connection to a PC or other host device, and at least one USB port for a peripheral device other than said host USB input port, and left and right stereo speakers; and
said chassis further including a powered USB hub connected to said USB ports, keyboard, and touchpad, and a display controller with audio capability for said video display.
